(19) United States
(12) Patent Application Publication
(10) Pub. No.: US 2007/0186376 A1
(43) Pub. Date: Aug. 16, 2007

(54) Floor spring

(75) Inventors: Volker Bienek, Dortmund (DE); Stephan Gosch, Riepsdorf (DE)

Correspondence Address: COHEN, PONTANI, LIEBERMAN & PAVANE, 551 FIFTH AVENUE, SUITE 1210, NEW YORK, NY, 10176, US

(73) Assignee: Dorma Gmbh + Co. KG, Ennepetal (DE)

(21) Appl. No.: 10/569,058

(22) PCT Filed: Aug. 10, 2004
(86) PCT No.: PCT/EP04/08921

§ 371 Date: Feb. 22, 2006

(30) Foreign Application Priority Data
Aug. 22, 2003 (DE) 103 39 106.1

(51) Int. Cl. E05F 1/10

(52) U.S. Cl. 16/79

(57) ABSTRACT

A floor-concealed door closer includes a housing for holding a door closing mechanism having an axle, and a housing cover for mounting on the housing and supporting the axle. The housing cover has transverse sides provided with lateral projections, each lateral projection having a stiffening flange.

The invention relates to a floor-concealed door closer with a housing for holding a closing mechanism, where the housing is covered by a housing cover, which supports the closing mechanism's axle, which carries a door or the like.

Floor-concealed door closers of this type are well known. They have a housing, in which the actual closing mechanism of the door closer is installed. An axle extends out from the housing. This axle supports the door or the like to be actuated. The housing can be closed by a housing cover, which supports the axle and which can be connected to the housing preferably by screws. A housing cover of this type is described in, for example, DE 295 01 929.8 U1.

A general requirement on the design of floor-concealed door closers is that the housing must be as flat as possible. To satisfy this requirement, a floor-concealed door closer with two springs is provided. This means in turn, however, that a larger hole must be provided in the floor-concealed door closer for the axle which supports the door, etc. As a result, the stiffness of the housing cover as a whole is decreased, and deformations of the housing cover can lead to problems with the operation of the floor-concealed door closer.

The task of the present invention is therefore to create a floor-concealed door closer which guarantees trouble-free operation even though it is of a flat design.

This task is accomplished for a floor-concealed door closer of the type explained above in that the housing cover has a stiffening shoulder in at least one edge area.

As a result of the inventive stiffening shoulder, it is guaranteed that the housing cover, even though it may be relatively flat, will not become deformed, so that the door or the like can be operated without difficulty at any time.

The subclaims present additional embodiments of the inventive object.

An especially low-distortion design of the housing cover can be obtained in accordance with a preferred embodiment by providing a stiffening shoulder on the end surface and additional stiffening shoulders on the transverse sides.

The inventive object is explained in greater detail on the basis of an exemplary embodiment illustrated in the drawings:

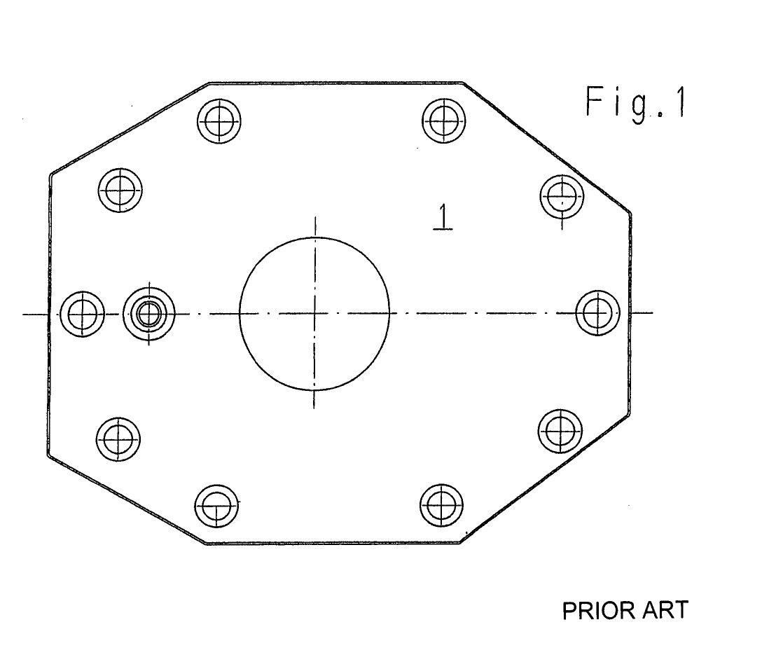

FIG. 1 shows a view from above of a housing cover according to the state of the art;

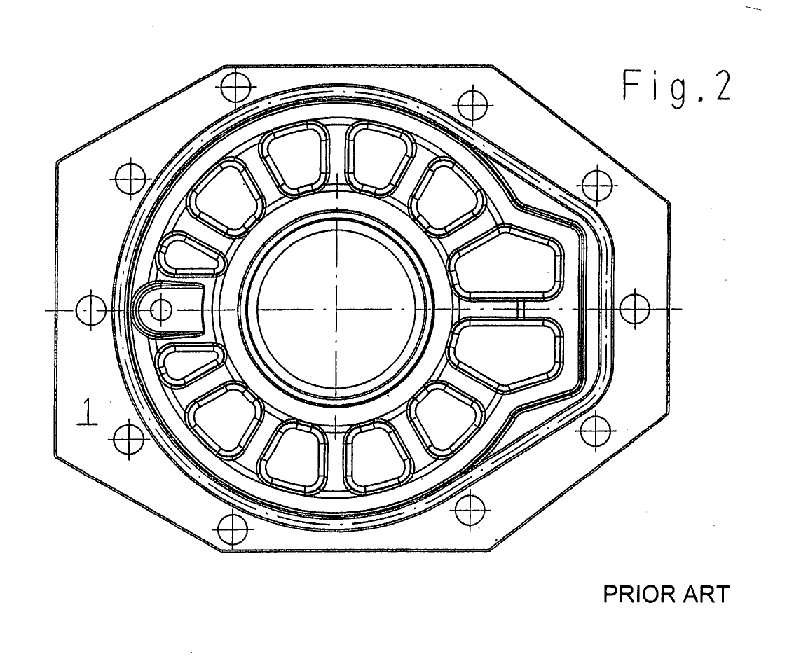

FIG. 2 shows a view from below of the housing cover according to FIG. 1;

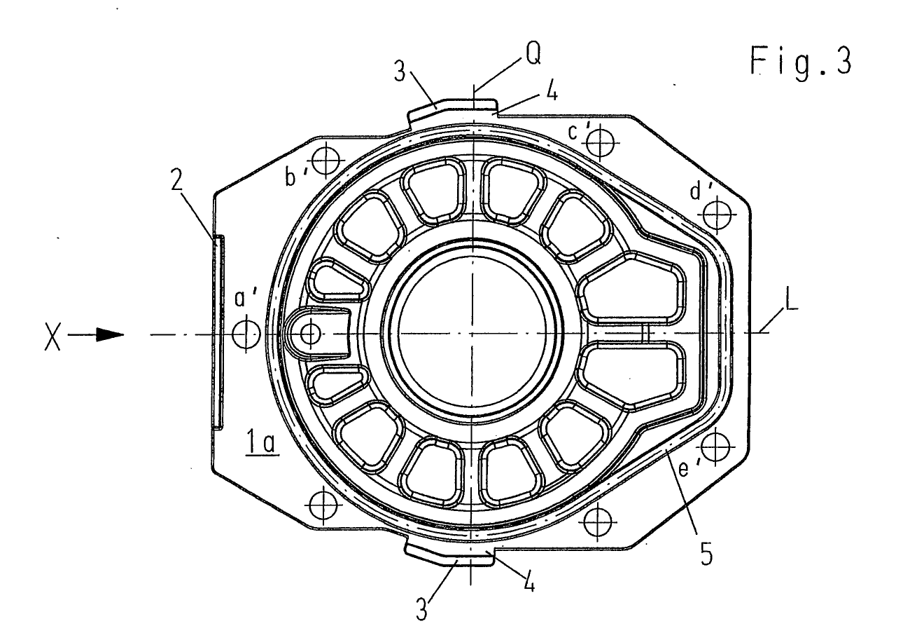

FIG. 3 shows a view from below of the inventive housing cover;

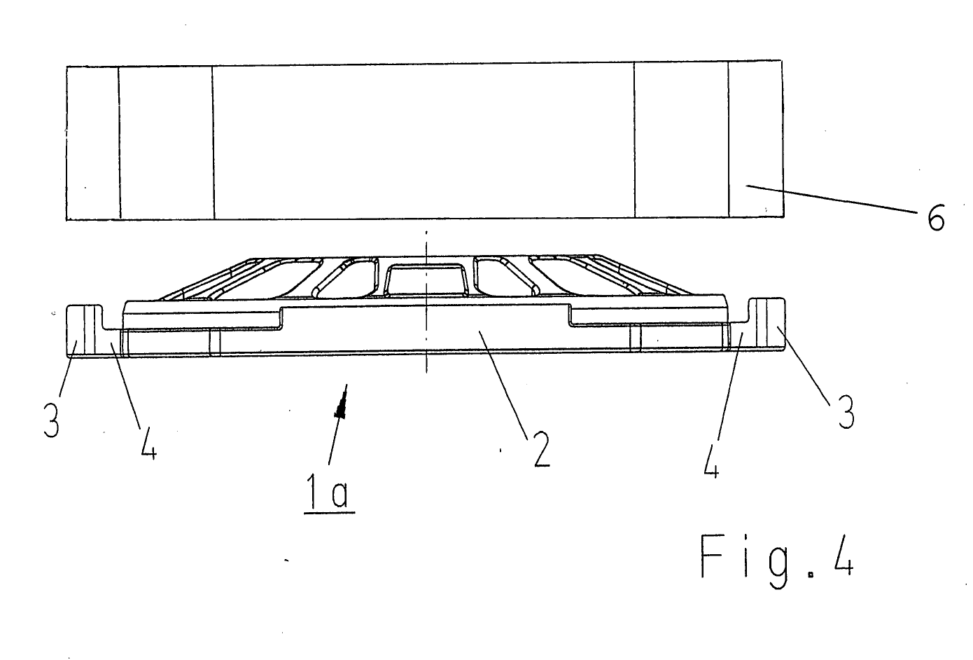

FIG. 4 shows a view of the inventive housing cover looking in the direction of arrow X in FIG. 3; and

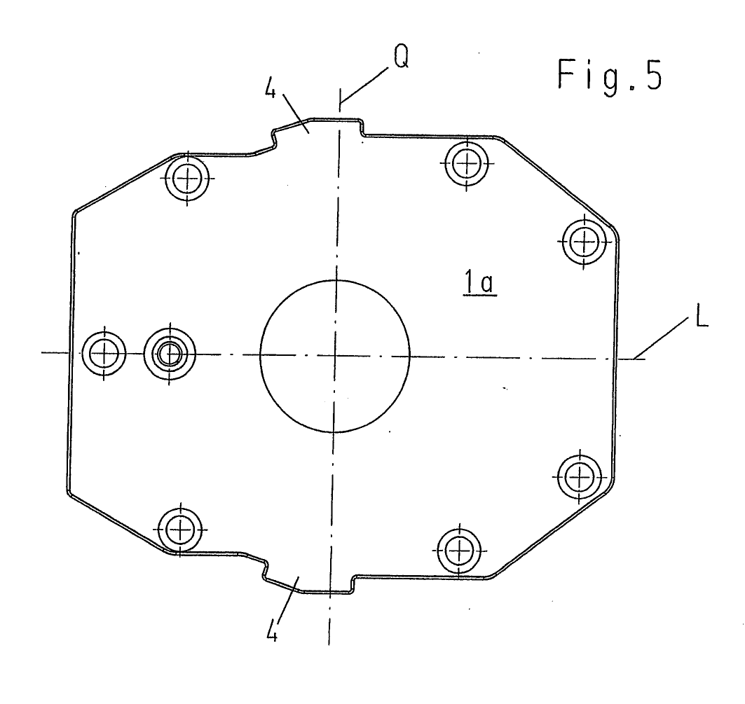

FIG. 5 shows the inventive housing cover from above.

Only the housing cover 1 of interest is shown in the figures; the rest of the floor-concealed door closer is omitted.

FIG. 3 shows a view of the inventive housing cover 1a from below. FIG. 5 shows the same housing cover 1a from above, and FIG. 4 a view looking in the direction of the arrow X in FIG. 3.

The housing cover 1a is provided in the conventional manner with screw holes a‘-e’, into which screws can be inserted to connect the housing cover 1a to a housing (not shown) of a floor-concealed door closer.

As can be seen in the figures, stiffening shoulders 2, 3 are provided, which project from the bottom surface of the housing cover 1a.

One of the stiffening shoulders 2, 3, namely, the stiffening shoulder 2, is flush with an end surface of the housing cover 1a and is centered on a longitudinal center axis L of the housing cover 1a. It is straight and extends essentially at a right angle to the center longitudinal axis L.

The two other stiffening shoulders 3 are provided on the transverse sides of the housing cover 1a. They are intersected by a transverse center axis Q of the housing cover 1a and, instead of being straight like the stiffening shoulder 2, they have an inflection.

Instead of the inflection shown here, the stiffening shoulders 3 could also be curved, for example.

The stiffening shoulders 3 provided on the transverse sides of the housing cover 1a are formed on projections 4, which extend outward in the plane of the housing cover 1a in the direction of the transverse center axis Q. The stiffening shoulders 3 are flush in this case with the outer edge of the projections.

It is obvious that the stiffening shoulders could be located anywhere on the housing cover 1a. The arrangement can be symmetric or asymmetric with respect to the axes Q and/or L, nor is the shape is limited to a specific design.

### LIST OF REFERENCE NUMBERS

1 housing cover according to the state of the art
1a housing cover according to the invention
2 stiffening shoulder
3 stiffening shoulder
4 projection
L longitudinal center axis
Q transverse center axis
a′-e′ screw holes

1.-10. (canceled)

11. A floor-concealed door closer comprising:
a housing for receiving a door closing mechanism having an axle; and
a housing cover for mounting on the housing and supporting the axle, the housing cover having a pair of transverse sides provided with respective opposed lateral projections, each said lateral projection having a stiffening flange.

12. The door closer of claim 11, wherein the housing cover further comprises an end surface having a stiffening flange which is flush with the end surface.

13. The door closer of claim 12, wherein the housing cover further has a longitudinal center axis, the stiffening flange on the end surface being centered on the longitudinal center axis.

14. The door closer of claim 13, wherein the housing cover further has a transverse center axis perpendicular to the longitudinal center axis and passing through the stiffening flanges on the transverse sides.

15. The door closer of claim 11, wherein the projection has a length and the stiffening flange on the projection has the same length as the projection.

16. The door closer of claim 12, wherein the stiffening flange on the end surface is straight.

17. The door closer of claim 11, wherein the stiffening flange on each said lateral projection is inflected.

18. The door closer of claim 11, wherein the stiffening flange on each said lateral projection is curved.

19. The door closer of claim 12, wherein each said stiffening flange projects into the housing when the housing cover is mounted on the housing.
